(19) United States
(12) Patent Application Publication
(10) Pub. No.: US 2018/0218438 A1
(43) Pub. Date: Aug. 2, 2018

(54) SYSTEM AND METHOD FOR DATABASE QUERYING AND MATCHING AT PARENT ITEM LEVEL

(71) Applicant: ORACLE INTERNATIONAL CORPORATION, Redwood Shores, CA (US)

(72) Inventors: Jurgen R. SCHROEDER, Plymouth, MN (US); Gerald J. HANSON, Apple Valley, MN (US); Dmitriy UCHENIK, Burnsville, MN (US); Anandamohan SEKAR, Edina, MN (US)

(21) Appl. No.: 15/421,553

(22) Filed: Feb. 1, 2017

(51) Int. Cl. G06Q 30/06; G06F 17/30; G06Q 30/04

(52) U.S. Cl. CPC G06Q 30/0633; G06Q 30/04; G06F 17/30598; G06F 17/30483

(57) ABSTRACT

Systems, methods, and other embodiments associated with invoice record matching at a parent item level are described. In one embodiment, a method includes querying an invoice record database, a receipt record database, and/or a purchase order database to identify invoices, receipts, and purchase orders listing child items categorized under a parent item. The example method may also include parsing the invoices, the receipts, and the purchase orders to identify invoiced child items, received child items, and ordered child items categorized under the parent item. The example method may also include executing a comparing operation to compare quantity metrics and cost metrics of the invoiced child items, the received child items, and the ordered child items to determine whether a quantity match within a quantity threshold tolerance and a cost match within a cost threshold tolerance are determined.

### BACKGROUND

Many retailers sell items that are ordered from vendors. For example, a grocery retailer orders yogurt, bread, meat, and a variety of other grocery items from various food vendors. When ordering items, a retailer submits a purchase order to the vendor. The purchase order lists quantities, prices, and/or other aspects of ordering items from the vendor. The vendor will ship items to the retailer, which are tracked as received items by a receipt. The receipt record specifies received quantities of items from the vendor. The vendor will provide the retailer with an invoice record listing invoiced items, costs, and/or other invoice record information for which the vendor is billing the retailer.

Unfortunately, quantity and cost discrepancies can arise between items that the retailer ordered, received, and is invoiced. Manually comparing thousands of invoices, receipts, and purchase orders of the retailer ordering a variety of items from different vendors is impractical and error prone. For example, the grocery retailer may operate thousands of stores that receive daily orders of grocery items from thousands of food vendors. Summary level matching is used to compare a total invoice quantity and price with a total ordered/received quantity and price. Summary level matching does not provide an adequate level of granularity for identifying particular discrepancies. Accordingly, line item matching is used to compare individual line item stock keeping units (SKUs) to identify individual discrepancies. This requires that each cost and quantity overage and underage must be manually addressed per item. However, many retailers are okay when they receive a slight variation in assortment of an item, such as a different assortment of yogurt flavors. Thus, line item matching will flag numerous false positives for which the retailer does want to be bothered with for further manual review.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates an embodiment of a system associated with invoice record matching at a parent item level.

FIG. 2 illustrates an embodiment of a method associated with invoice record matching at a parent item level.

FIG. 3 illustrates an embodiment of a system associated with invoice record matching at a parent item level, where a matching interface is used to define parent level matching rules.

FIG. 4 illustrates an embodiment of a system associated with invoice record matching at a parent item level, where a cost match result and quantity match result are determined from an invoice, a receipt, and a purchase order.

FIG. 5 illustrates an embodiment of a system associated with invoice record matching at a parent item level, where a data structure is updated to indicate matches between an invoice record and receipt.

FIG. 6 illustrates an embodiment of a non-transitory computer-readable medium.

FIG. 7 illustrates an embodiment of a computing system configured with the example systems and/or methods disclosed.

### DETAILED DESCRIPTION

Computerized systems and methods are described herein that provide for invoice record matching at a parent item level. A retailer, such as a clothing retailer, stocks sellable items that are ordered from vendors. For example, the clothing retailer sells various sizes and colors of male and female clothing. Each sellable item is marked with a stock keeping unit (SKU). The retailer can logically group multiple sellable items under a category referred to as a parent item or style. In this grouping, a sellable item categorized under a parent item is referred to as a child item. Multiple child items can be categorized under the parent item. In one embodiment, the clothing retailer could group different colors and sizes of a men's running jacket under a men's running jacket parent item. Each size/color combination is a child item having its own SKU. In another embodiment, a grocery retailer could group different flavors of a yogurt brand ABC into a yogurt brand ABC parent item. Each flavored yogurt container is a child item having its own SKU. Thus, child items with different SKUs can be categorized under the same parent item.

When ordering items from a vendor, the retailer submits a purchase order of ordered items such as a mixture of different flavors of yogurt. The vendor will ship items that are received as received items. In one embodiment, the received items are a slightly different assortment of yogurt flavors than what was ordered. The received items are tracked within a receipt. The vendor provides the retailer with an invoice record of invoiced items, such as quantities and costs of yogurt containers. Accordingly, it is advantageous to compare the invoice, the receipt, and the purchase order at a parent item level granularity. Parent item level matching compares a total quantity and unit cost of invoiced and ordered/received yogurt containers categorized under the yogurt brand ABC parent item.

Parent item level matching is different than summary level matching. Summary level matching will evaluate an invoice record to identify a total quantity of invoiced items of the entire invoice record and a total cost of the entire invoice, such as a total quantity and cost invoiced for yogurt, cheese, bread, turkey, paper towels, and/or other items that may or may not be related. The total quantity and total cost are compared with a total quantity and cost of a purchase order and/or receipt. In this way, summary level matching will identify whether an entire invoice record matches what the purchase order and/or receipt. However, summary level matching does not identify specific discrepancies such as what related items were shorted or what related items were invoiced at a different cost. Instead, summary level matching merely identifies whether a total invoice record cost and total invoice record quantity of all items within an entire invoice record matches or does not match a total quantity of received items of the receipt record and a total cost of ordered items of the purchase order irrespective of the type of items.

In contrast to summary level matching, parent item level matching can identify discrepancies between what related items are invoiced compared to what related items were ordered/received at a categorical level of a parent item. That is, a user can specify what child items are to be categorized/grouped under a parent item. The parent item is a category and not a sellable item with a SKU. However, child items are sellable items with SKUs. Thus, the user can select what SKUs to group under the parent item (e.g., SKUs of various flavors of yogurt are grouped under the yogurt brand ABC parent item, but SKUs of bread, paper towels, cheese, etc. are not). Parent item level matching will compare only those child items of a parent item when determining whether a total quantity and cost of invoiced child items of that parent item match what was ordered/received within a threshold tolerance. Thus, parent item level matching can determine whether a quantity and cost of invoiced yogurt child items, irrespective of flavor, matched the quantity and cost of ordered/received yogurt child items within threshold tolerances without taking into account other types of items such as turkey or bread. In contrast, summary level matching would compare turkey and/or other items that are not grouped under the yogurt brand ABC parent item.

Parent item level matching is different than line item level matching. Line item level matching evaluates quantities and costs of individual line items of an invoice record to what individual items are ordered/received. Line item level matching will determine whether the correct quantity and cost were invoiced for cherry yogurt, whether the correct quantity and cost were invoiced for lime yogurt, whether the correct quantity and cost were invoiced for strawberry yogurt, whether the correct quantity and cost were invoiced for cheese, whether the correct quantity and cost were invoiced for turkey, etc. Line item level matching is performed at such a fine level of granularity of individual items that groupings of related items, such as different flavors of yogurt, are not considered as a group. Thus, even though a retailer may be okay with receiving a slight variation in an assortment of yogurt flavors than what was ordered/received, line item level matching will still flag each line item flavor that does not match.

In contrast to line item level matching, parent item level matching can determine a match even if there is a variation in an assortment of what related child items are invoiced compared to what was ordered/received. Thus, a match can be determined if a total quantity and unit cost of yogurt flavors invoiced is within a threshold tolerance of quantities and unit cost of yogurt ordered/received even if individual quantities of flavors do not exactly match.

Comparing at the parent item level allows the retailer to provide a cost tolerance and a quantity tolerance that is applied to all child items of a parent item as a whole. The cost tolerance and quantity tolerance allows the retailer to accept variations amongst child items of the parent item. In one embodiment, the grocery retailer will accept an invoice record for yogurt even if the assortment of flavors is different than what was ordered and the invoiced price is within a threshold amount or percentage of the ordered price.

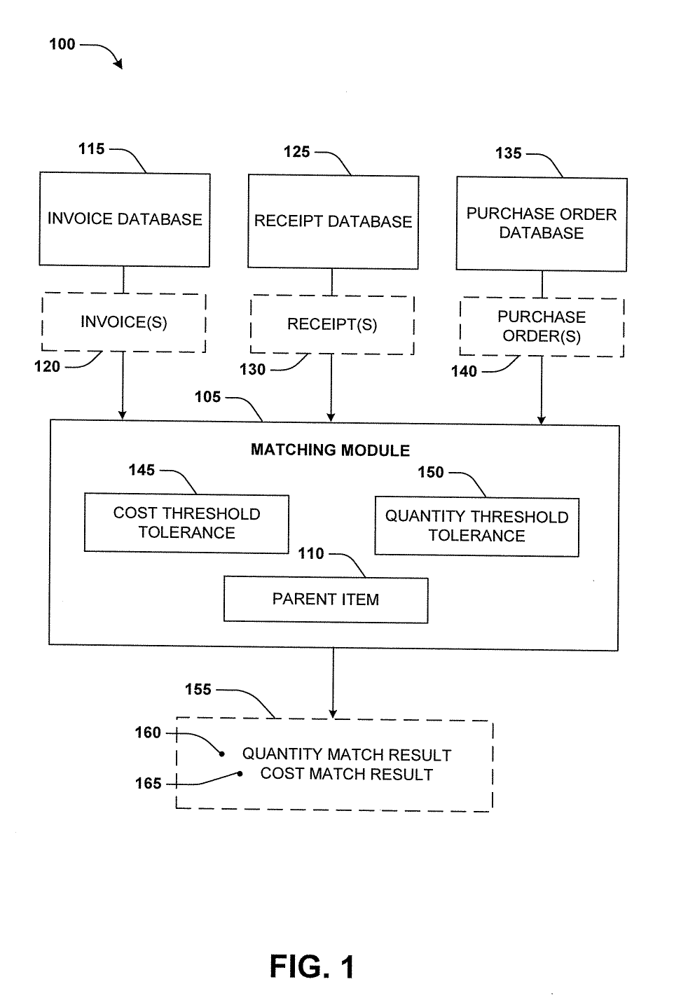

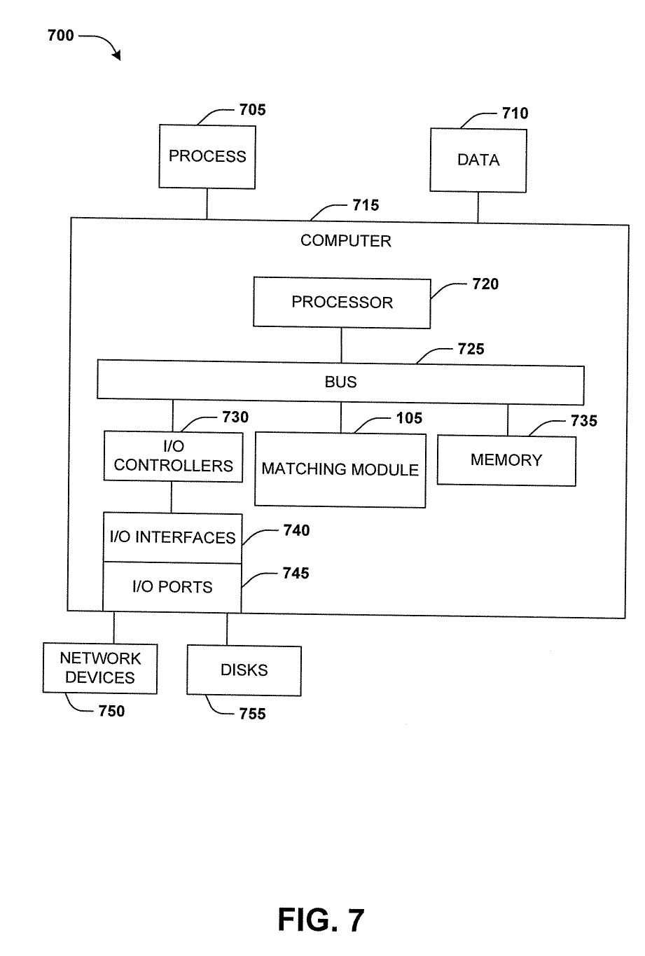

With reference to FIG. 1, one embodiment of a computer system 100 associated with invoice record matching at a parent item level is illustrated. The system 100 includes a matching module 105, which can be configured to execute on a computer, such as computer 715 of FIG. 7. The matching module 105 is configured to perform automated computerized matching between invoices 120, receipts 130, and purchase orders 140 at the parent item level. The parent item level corresponds to a parent item 110 under which multiple child items are categorized. The parent item 110 relates to a categorical description of a consumer good, such as a style of clothing. The parent item 110 does not have a stock unit number (SKU) and thus is not a sellable item in and of itself. In one embodiment, the parent item 110 comprises a men's brand ABC t-shirt.

A child item is a sellable item with an SKU. In one embodiment, the child item comprises a medium red men's brand ABC t-shirt that is physically stocked and sold by a retailer. Multiple different child items with different SKUs are categorized/grouped under the parent item 110. In one embodiment, different combinations of colors and sizes of the men's brand ABC t-shirt are child items of the men's brand ABC t-shirt parent item such as a red large t-shirt, a red small t-shirt, a blue large t-shirt, etc. A parent child relationship that categorizes child items under the parent item 110 can be user defined such as by the retailer.

The matching module 105 is configured to query an invoice record database 115 that contains invoice records where the query includes a parent identifier of the parent item 110 to retrieve invoice records 120 where each invoice record identifies a set of invoiced child items that are categorized under the parent item 110 for the associated invoice record. In one embodiment using the t-shirt example, the invoice records 120 comprise an invoice record that lists child items of the men's brand ABC t-shirt parent item and/or child items of other parent items. Suppose in one example the invoiced child items comprise 5 red large t-shirts, 6 blue large t-shirts, and 7 green small t-shirts as being invoiced from a vendor to the retailer at a unit cost of $6.08.

The invoice record is an electronic document that is converted and stored as a data record in the invoice record database 115. The invoice record from the vendor to the retailer requests that the retailer pay the vendor a certain price for the child items listed within the invoice. The invoice record requests payment of $109.44 for the 18 t-shirts at $6.08 each. The matching module 105 is configured to parse the invoices 120 to identify the set of invoiced child items, categorized under the parent item 110, of the invoices 120. In this way, the invoiced child items of the parent item 110 are identified for parent level item matching for the parent item 110. However, other invoiced items that are not categorized/grouped under the parent item 110, such as shoes, are not considered by the parent level item matching. In one embedment, various combinations of colors and sizes of t-shirts categorized under the parent item 110, but not hats, running jackets, socks, and other invoiced items that are not categorized under the parent item 110, are identified for parent item level match.

The matching module 105 is configured to query a receipt record database 125 using the parent identifier of the parent item 110 to retrieve receipts 130 listing a set of received child items that are categorized under the parent item 110. In one embodiment, the receipts 130 comprise a receipt record listing child items of the men's brand ABC t-shirt parent item and/or child items of other parent items. The child items comprise 5 red large t-shirts, 5 blue large t-shirts, 1 pink medium t-shirt, and 6 green small t-shirts as being received from the vendor for a total of 17 t-shirts. The receipt record is a document generated to track what items were actually received from the vendor. The receipt record indicates that the vendor shorted the retailer by 1 t-shirt from what was invoiced.

The matching module 105 is configured to parse the receipts 130 to identify a set of received child items, categorized under the parent item 110, of the receipts 130. In this way, the received child items of the parent item 110, but not other received items listed in the receipts 130, are identified for parent level item matching for the parent item 110. In one embedment, various combinations of colors and sizes of t-shirts categorized under the parent item 110, but not swimsuits, shoes, and other received items that are not categorized under the parent item 110, are identified for parent item level match.

In one embodiment, the retailer specifies that substitute items are acceptable in place of child items of the parent item 110. A substitute item is not categorized under the parent item 110. That is, a SKU of the substitute item is not categorized under the parent item 110. In one embodiment, the substitute item is a red large sweatshirt that the retailer is okay with receiving in place of a child item of the men's brand ABC t-shirt parent item. Accordingly, the receipts 130 are parsed to identify one or more substitute items, such as the red large sweatshirt. The one or more substitute items are included within the set of received child items.

The matching module 105 is configured to query a purchase order database 135 using the parent identifier of the parent item 110 to retrieve purchase orders 140 listing a set of ordered child items that are categorized under the parent item 110. In one embodiment, the purchase orders 140 comprise a purchase order listing child items of the men's brand ABC t-shirt parent item and/or child items of other parent items. The child items comprise 5 red large t-shirts, 6 blue large t-shirts, and 7 green small t-shirts as being ordered from the vendor by the retailer at a unit cost of $6.00. The purchase order indicates that the retailer ordered t-shirts at $0.08 less than what the vendor is invoicing the retailer for the t-shirts.

The matching module 105 is configured to parse the purchase orders 140 to identify a set of ordered child items, categorized under the parent item 110, of the purchase orders 140. In this way, the ordered child items of the parent item 110, but not other ordered items listed in the purchase orders 140, are identified for parent level item matching for the parent item 110. In one embedment, various combinations of colors and sizes of t-shirts categorized under the parent item 110, but not makeup, perfume, and other ordered items that are not categorized under the parent item 110, are identified for parent item level match.

It may be appreciated that the invoice record database 115, the receipt record database 125, and/or the purchase order database 135 are the same or different databases.

The matching module 105 is configured to utilize a cost threshold tolerance 145 and/or a quantity threshold tolerance 150 when comparing child items of the invoices 120, the receipts 130, and/or the purchase orders 140 to determine if the retailer received an acceptable mix of child items of the parent item 110. That is, the cost threshold tolerance 145 and/or the quantity threshold tolerance 150 are applied at a parent item level as opposed to a summary level or a line item level. The summary level compares a total invoice record quantity and cost of an invoice record with total quantities and costs of a receipt record and purchase order to see if the total quantity and cost of what is invoiced matches what was received/ordered. Summary level matching takes into account all items, such as perfume, clothing, shoes, and/or other items even if they are not categorized under the parent item 110. Line item level compares each invoiced line item to see if the quantity and cost of that line item match what was received/ordered. Neither summary level matching nor line item level matching compare only child items of a particular parent item 110 for determined whether a match exists.

In contrast to summary and line item level matching, parent item level matching will group together child items of the parent item 110 to determine whether a portion of an invoice record that relates to quantity and cost of the grouped child items matches portions of the receipt record and purchase order that relate to the quantity and cost of the grouped child items that were received/ordered. In one embodiment, an invoice record lists child items categorized under the parent item 110 such as the 5 red large t-shirts, 6 blue large t-shirts, and 7 green small t-shirts that are child items of the men's brand ABC t-shirt parent item. The invoice record also lists other items are not categorized under the men's brand ABC t-shirt parent item, such as a woman's bathing suit, 6 pairs of socks, 7 ties, etc. Accordingly, parent item level matching will consider and compare the 5 red large t-shirts, 6 blue large t-shirts, and 7 green small t-shirts, but will not consider and compare the woman's bathing suit, 6 pairs of socks, 7 ties, or other items not categorized under the men's brand ABC t-shirt parent item. This logic also applies to receipts and purchase orders where merely child items of the men's brand ABC t-shirt parent item are considered and compared.

The cost threshold tolerance 145 specifies an amount of deviation as a number or percentage that is acceptable (still considered a match) between an invoiced unit cost of a child item as invoiced by the vendor and an ordered unit cost of the child item as ordered by the retailer. In one embodiment, the cost threshold tolerance 145 indicates that the retailer is okay if child items categorized under the men's brand ABC t-shirt parent item have a 3% over/under deviation between the cost of what was invoiced and what was ordered.

The quantity threshold tolerance 150 specifies an amount of deviation as a number or percentage that is acceptable (still considered a match) between a total count of invoiced child items and a total count of ordered/received child items. In one embodiment, the quantity threshold tolerance 150 specifies that the retailer is okay if child items categorized under the men's brand ABC t-shirt parent item have a 6% over/under deviation between the quantity of what was invoiced and what was ordered.

The matching module 105 performs a comparing operation to compare costs and quantities of invoiced child items, received child items, and ordered child items to determine whether a match is determined or not. The matching module 105 executes the comparing operation to compare a first quantity metric of the set of invoiced child items with a second quantity metric of the set of received child items to determine whether the first quantity metric is within the quantity threshold tolerance 150 of the second quantity metric. The first quantity metric corresponds to a count of invoiced child items and the second quantity metric corresponds to a count of received child items. In one embodiment, the comparing operation compares a count of invoiced child items having SKUs categorized under the parent item 110 with a count of received child items having SKUs categorized under the parent item 110. In this way, if a total count of invoiced child items of the parent item 110 are within the 6% deviation tolerance of the count of the received child items, then a first quantity match is determined that the invoiced child items match the received child items.

The matching module 105 executes the comparing operation to compare the first quantity metric of the set of invoiced child items with a third quantity metric of the set of ordered child items to determine whether the first quantity metric is within the quantity threshold tolerance 150 of the third quantity metric. The first quantity metric corresponds to the count of invoiced child items and the third quantity metric corresponds to a count of ordered child items. In one embodiment, the comparing operation compares a count of invoiced child items having SKUs categorized under the parent item 110 with a count of ordered child items having SKUs categorized under the parent item 110. In this way, if a total count of invoiced child items of the parent item 110 are within the 6% deviation tolerance of the count of ordered child items, then a second quantity match is determined that the invoiced child items match the ordered child items.

The matching module 105 executes the comparing operation to compare a first cost metric of the set of invoiced child items with a second cost metric of the set of received child items to determine whether the first cost metric is within the cost threshold tolerance 145 of the second cost metric. The first cost metric corresponds to a unit cost of invoiced child items and the second cost metric corresponds to a unit cost of received child items. In this way, if a unit cost of invoiced child items of the parent item 110 are within the 3% deviation tolerance of the unit cost of the receive child items, then a first cost match is determined that the invoiced child items match the received child items.

The matching module 105 executes the comparing operation to compare the first cost metric of the set of invoiced child items with a third cost metric of the set of ordered child items to determine whether the first cost metric is within the cost threshold tolerance 145 of the third cost metric. The first cost metric corresponds to the unit cost of invoiced child items and the third cost metric corresponds to a unit cost of ordered child items. In this way, if a unit cost of invoiced child items of the parent item 110 are within the 3% deviation tolerance of the unit cost of the ordered child items, then a second cost match is determined that the invoiced child items match the ordered child items.

It may be appreciated that the comparing operation may be executed to compare other combinations of metrics, such as comparing quantity and/or costs of received child items to quantity and/or costs of ordered child items.

If the matching module 105 determines that the quantity metrics match within the quantity threshold tolerance 150, then the matching module 105 will modify a data structure 155 to indicate a quantity match 160 for the parent item 110. If the matching module 105 determines that the cost metrics match within the cost threshold tolerance 145, then the matching module 105 will modify the data structure 155 to indicate a cost match 165 for the parent item 110.

If the matching module 105 determines that the quantity metrics do not match within the quantity threshold tolerance 150, then the matching module 105 will provide a match fail result. If the matching module 105 determines that the cost metrics do not match within the cost threshold tolerance 145, then the matching module 105 will provide the match fail result. The match fail result may be provided through a user interface, a database entry, an annotation or modification to a document, etc. In one embodiment, the matching module 105 may apply a pro-rate metric across the child items to compensate for any cost discrepancy. In this way, parent item level matching is performed, such as in an automated manner or through an online user interface. If there is an overall match, then that is an indication to the retailer that the retailer should accept and pay for the invoice record with regards to the child items of the parent item 110. The online user interface allow users to specify what parent items to match, specify threshold tolerances, specify vendors to match, and/or select invoices, receipts, and/or purchase orders to compare.

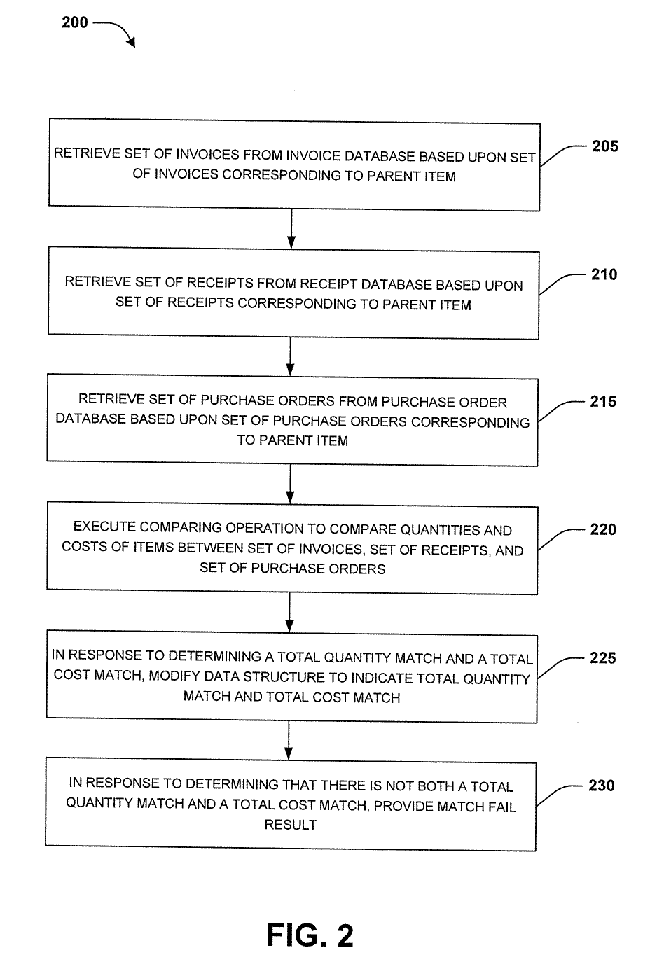

With reference to FIG. 2, one embodiment of a computer implemented method 200 associated with invoice record matching at a parent item level is illustrated. In one embodiment, the method 200 is performed by the matching module 105 utilizing various computing resources of the computer 715, such as the processor 720 for executing instructions associated with executing a comparing operation. Memory 735 and/or disks 755 are used for storing a cost threshold tolerance 145, a quantity threshold tolerance 150, comparing operation instructions, etc. Network hardware is used for communicating data structures between the computer 715 and remote computers over a network. The method 200 is triggered upon a command to match invoices, receipts, and purchase orders for a parent item level matching.

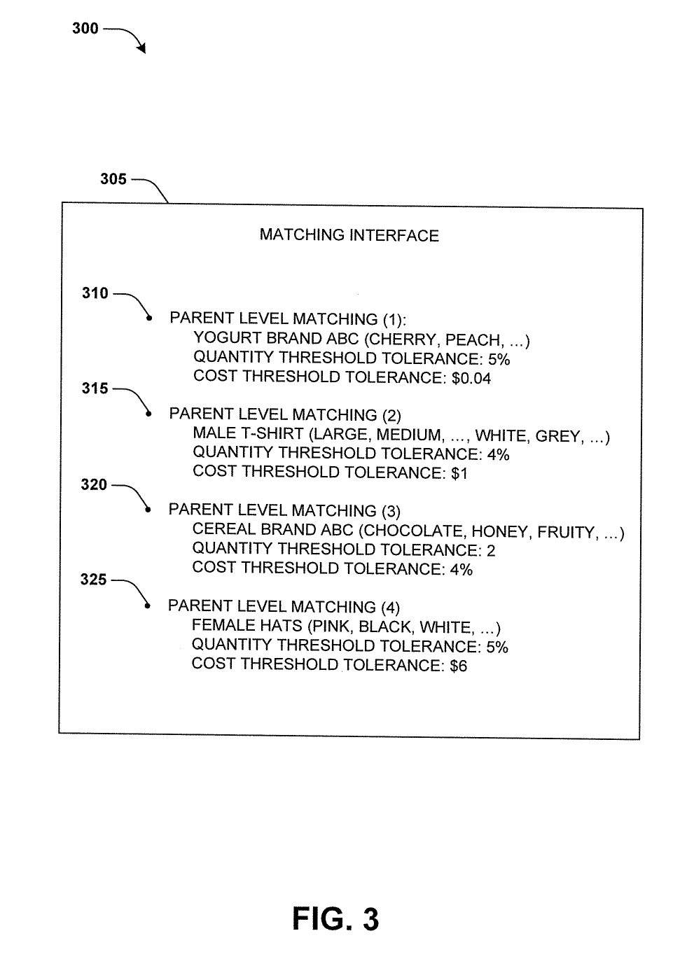

The method 200 implements parent item level matching, which can be defined through a matching interface 305 such as an online user interface; illustrated by example system 300 of FIG. 3. In one embodiment, a retailer defines a first parent level matching rule 310 for a yogurt brand ABC parent item. The yogurt brand ABC parent item is associated with child items that are sellable items with SKUs, such as a cherry flavor yogurt cup, a peach flavored yogurt cup, etc. The first parent level matching rule 310 specifies a first quantity threshold tolerance of 5%. The first quantity threshold tolerance of 5% indicates that the retailer is willing to accept a 5% difference between a total count of invoiced child items of the yogurt brand ABC parent item and a total count of received and/or ordered child items of the yogurt brand ABC parent item. The first parent level matching rule 310 is indicative of the retailer being willing to accept various assortments of yogurt flavors than what was ordered. The first parent level matching rule 310 specifies a first cost threshold tolerance of $0.04. The first cost threshold tolerance of $0.04 indicates that the retailer is willing to accept a $0.04 difference between a unit cost of invoiced child items of the yogurt brand ABC parent item and a unit cost of ordered child items of the yogurt brand ABC parent item. It may be appreciated that cost threshold tolerances and/or quantity threshold tolerances may be defined as percentages, numeric values, monetary values, etc.

The retailer defines a second parent level matching rule 315 for a male t-shirt parent item. The male t-shirt parent item is associated with child items that are sellable items with SKUs, such as combinations of different colors and sizes of the male t-shirt. The second parent level matching rule 315 specifies a second quantity threshold tolerance of 4%. The second quantity threshold tolerance of 4% indicates that the retailer is willing to accept a 4% difference between a total count of invoiced child items of the male t-shirt parent item and a total count of received and/or ordered child items of the male t-shirt parent item. The second parent level matching rule 315 is indicative of the retailer being willing to accept various assortments of colors and sizes of male t-shirts than what was ordered. The second parent level matching rule 315 specifies a second cost threshold tolerance of $1. The second cost threshold tolerance of $1 indicates that the retailer is willing to accept a $1 difference between a unit cost of invoiced child items of the male t-shirt parent item and a unit cost of ordered child items of the male t-shirt parent item.

The retailer can defined various other parent level matching rules though the matching interface 305. In one embodiment, the retailer defines a third parent level matching rule 320 for a cereal brand ABC parent item having child items such as a chocolate flavored cereal, a honey flavored cereal, a fruity flavored cereal, and/or other sellable cereal items with SKUs. The retailer defines a fourth parent level matching rule 325 for a female hat parent item having child items such as a pink hat, a black hat, a white hat, and/or other sellable female hat items with SKUs.

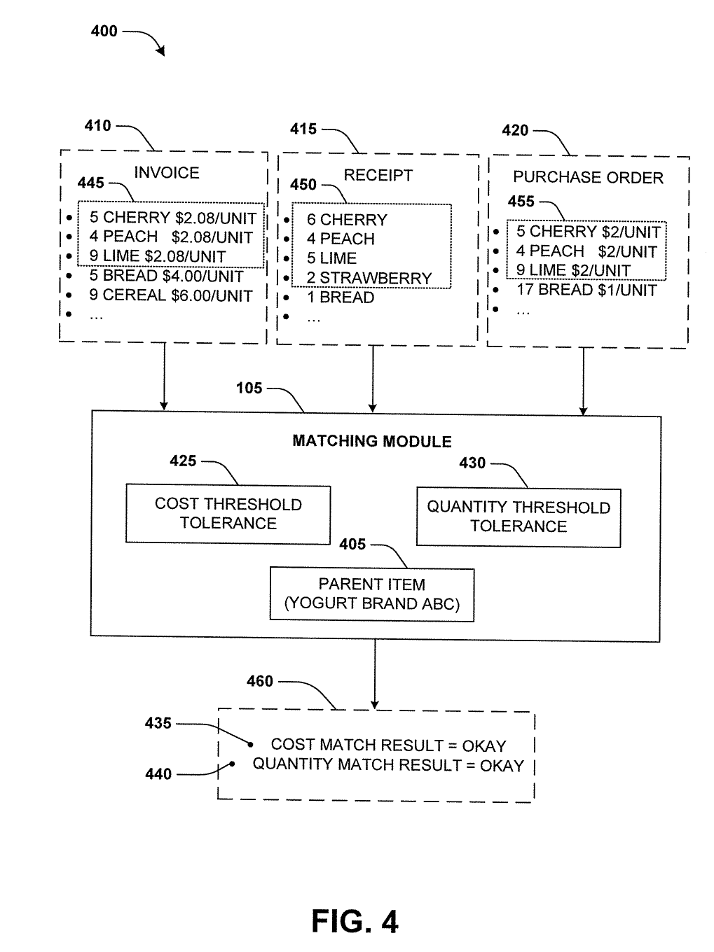

In one embodiment, the matching module 105 performs parent item level matching for a yogurt brand ABC parent item 405, as illustrated by example system 400 of FIG. 4. At 205, the invoice record database 115 is queried using a parent identifier of the yogurt brand ABC parent item 405 to retrieve a set of invoices listing invoiced child items that are characterized under the yogurt brand ABC parent item 405. The set of invoices comprise an invoice record 410 listing a set of invoiced child items 445 that are characterized under the yogurt brand ABC parent item 405. In one embodiment, the set of invoiced child items 445 comprise 5 cherry yogurt child items at $2.08 per unit, 4 peach yogurt child items at $2.08 per unit, and 9 lime yogurt child items at $2.08 per unit. Because parent item level matching is performed, other items such as bread and cereal within the invoice record 410 are not considered for cost and quantity matching.

At 210, the receipt record database 125 is queried using the parent identifier of the yogurt brand ABC parent item 405 to retrieve a set of receipts listing received child items that are characterized under the yogurt brand ABC parent item 405. The set of receipts comprise a receipt record 415 listing a set of received child items 450 that are characterized under the yogurt brand ABC parent item 405. In one embodiment, the set of received child items 450 comprise 6 cherry yogurt child items, 4 peach yogurt child items, and 5 lime yogurt child items, and 3 strawberry child items. Because parent item level matching is performed, other items such as bread within the receipt record 415 are not considered for cost and quantity matching.

At 215, the purchase order database 135 is queried using the parent identifier of the yogurt brand ABC parent item 405 to retrieve a set of purchase orders listing ordered child items that are characterized under the yogurt brand ABC parent item 405. The set of purchase orders comprise a purchase order 420 listing a set of ordered child items 455 that are characterized under the yogurt brand ABC parent item 405. In one embodiment, the set of ordered child items 455 comprise 5 cherry yogurt child items at $2 per unit, 4 peach yogurt child items at $2 per unit, and 9 lime yogurt child items at $2 per unit. Because parent item level matching is performed, other items such as bread within the purchase order 420 are not considered for cost and quantity matching.

At 220, a comparing operation is performed to compare quantities and/or costs of child items between the set of invoices, the set of receipts, and the set or purchase orders. The comparing operation compares unit costs of invoiced child items 445, received child items 450, and ordered child items 455 based upon a cost threshold tolerance 425. In one embodiment, the comparing operation determines a cost match result 435 of a match based upon the $2 per unit price of the ordered child items 455 and the $2.08 unit price of the invoiced child items 445 being within the cost threshold tolerance 425 of 6%. Even though the unit costs are not an exact match, a match is still determined based upon the cost threshold tolerance 425. The match is determine notwithstanding other items, that are not child items of the yogurt brand ABC parent item 405, not being within the cost threshold tolerance 425 since parent item level matching is performed merely for the yogurt brand ABC parent item 405.

The comparing operation compares quantity metrics of invoiced child items 445, received child items 450, and ordered child items 455 based upon a quantity threshold tolerance 430. In one embodiment, the comparing operation determines a quantity match result 440 of a match based upon a count of 18 invoiced yogurt child items, a count of 17 received yogurt child items, and/or a count of 18 ordered yogurt child items being within the quantity threshold tolerance 430 of 10%. Based upon the cost match result 435 and the quantity match result 440 indicating matches, the matching module 105 modifies a data structure 460, such as a database entry, to indicate that a quantity match and a cost match were determined, at 225. Otherwise, if a match was not determined, then a match fail result is provided, at 230. The match fail result is provided through a database entry, an update to a document, and/or a user interface.

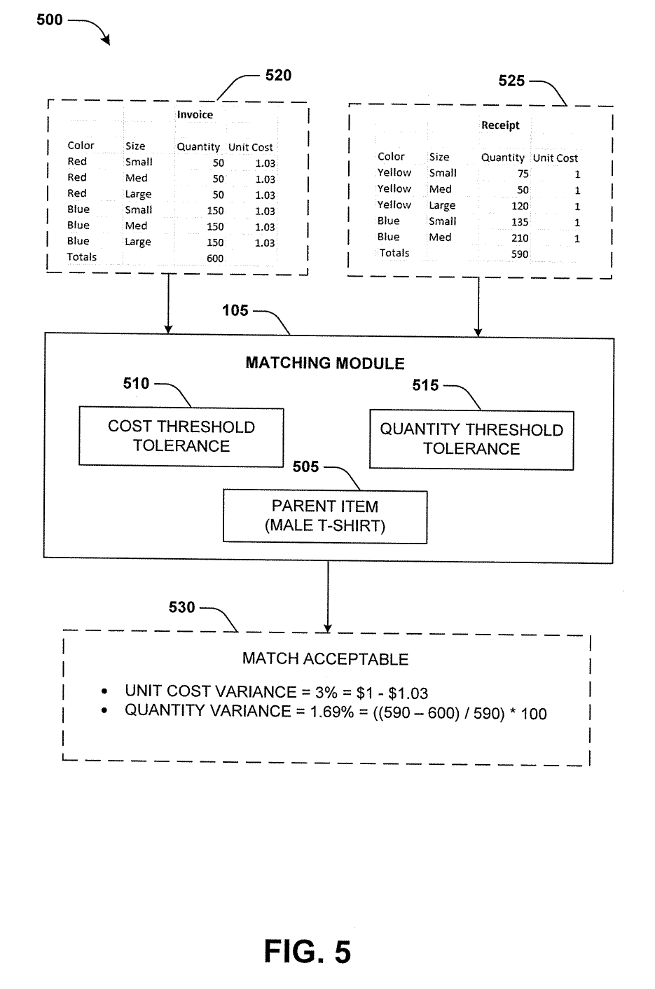

With reference to FIG. 5, one embodiment of a computer system 500 associated with invoice record matching at a parent item level is illustrated. The system 500 includes the matching module 105, which can be configured to execute on a computer, such as computer 715 of FIG. 7. The matching module 105 receives a command to perform parent item level matching for a male t-shirt parent item 505. Accordingly, the matching module 105 queries the invoice record database 115 to identify an invoice record 520 listing a set of invoiced child items of the male t-shirt parent item 505, such as 50 small red shirts at $1.03 each, 50 medium red shirts at $1.03 each, 50 large red shirts at $1.03 each, 150 small blue shirts at $1.03 each, 150 medium blue shirts at $1.03 each, and 150 large blue shirts at $1.03 each. The invoice record 520 may list other items that are not child items of the male t-shirt parent item 505, and thus are not considered by the matching module 105. The matching module 105 determines a first quantity metric of the invoiced child items as a count of 600 invoiced child items of the male t-shirt parent item 505. The matching module 105 determines a first cost metric of the invoiced child items as $1.03 per shirt.

The matching module 105 queries the receipt record database 125 to identify a receipt record 525 listing a set of received child items of the male t-shirt parent item 505, such as 75 small yellow shirts at $1, 50 yellow medium shirts at $1, 120 large yellow shirts at $1, 135 small blue shirts at $1, and 210 medium blue shirts at $1. The receipt record 525 may list other items that are not child items of the male t-shirt parent item 505, and thus are not considered by the matching module 105. The matching module 105 determines a second quantity metric of the received child items as a count of 590 received child items of the male t-shirt parent item 505. The matching module 105 determines a second cost metric of the received child items as $1 per shirt.

The matching module 105 executes a comparing operation to compare the first cost metric of $1.03 for invoiced child items and the second cost metric of $1 for received child items using the cost threshold tolerance 510 of 5%. The matching module 105 identifies unit cost variance of 3% based upon a calculation $1-$1.03. Because the cost variance of 3% between unit costs of child items received and invoiced is less than the cost threshold tolerance 510 of 5%, a cost match is determined.

The matching module 105 executes the comparing operation to compare the first quantity metric of 600 invoiced child items and the second quantity metric of 590 received child items using the quantity threshold tolerance 515 of 3%. The matching module 105 identifies a quantity variance of 1.69% based upon a calculation ((590-600)/590)*100. Because the quantity variance of 1.69% between child items received and invoiced is less than the quantity threshold tolerance 515 of 3%, a quantity match is determined.

The matching module 105 modifies a data structure 530 to indicate that the quantity match and the cost match were determined for the male t-shirt parent item 505. In one embodiment, the matching module 105 updates a database record of the matches. In another embodiment, the matching module 105 updates a document of the matches. In another embodiment, the matching module 105 populates a user interface with a notification of the matches. If a match had failed, then the matching module 105 may provide a match fail result, such as through a database record, an update to the document, or the user interface.

In an embodiment, item subset grouping is provided for invoice record matching. Item subset grouping provides for an ability to specify a subset of items within an invoice record and order receipt for matching at an aggregated level for that subset of items. In one embodiment, item subset grouping can comprise styles of child items, such as different sizes and colors, of a parent item. The child items will be considered acceptable substitutes for each other. Items with a common attribute, such as a same size, color, or flavor, can be considered acceptable substitutes for each other. Items that are part of a retailer defined list of items can be acceptable substitutes for each other. A process will attempt to match a subset of invoiced record item lines to order/receipt item lines based on configured groupings of items with similar characteristics at an aggregate level. The process will apply a tolerance defined for the group at that aggregate level to determine whether a match exists. Items on an order/receipt and invoice record are from a same parent item. Even though not all items are the same, they can match at an aggregate level within a defined tolerance.

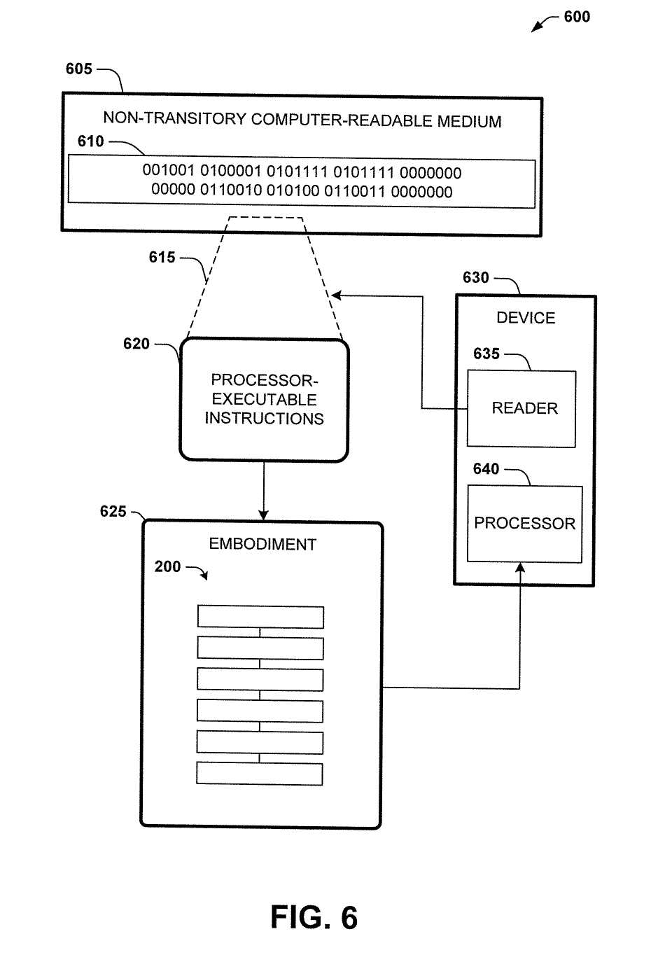

FIG. 6 is an illustration of a scenario 600 involving an example non-transitory computer-readable medium 605. In one embodiment, one or more of the components described herein are configured as program modules, such as the matching module 105, stored in the non-transitory computer-readable medium 605. The program modules are configured with stored instructions, such as processor-executable instructions 620, that when executed by at least a processor, such as processor 640, cause the computing device to perform the corresponding function(s) as described herein. In one embodiment, the, functionality of the matching module 105, stored in the non-transitory computer-readable medium 605, may be executed by the processor 640 as the processor-executable instructions 620 to perform an embodiment 625 of the method 200 of FIG. 2.

The non-transitory computer-readable medium 605 includes the processor-executable instructions 620 that when executed by a processor 640 cause performance of at least some of the provisions herein. The non-transitory computer-readable medium 605 includes a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory computer-readable medium 605 stores computer-readable data 610 that, when subjected to reading 615 by a reader 635 of a device 630 (e.g., a read head of a hard disk drive, or a read operation invoked on a solid-state storage device), express the processor-executable instructions 620.

In some embodiments, the processor-executable instructions 620, when executed cause performance of operations, such as at least some of the example method 200 of FIG. 2, for example. In some embodiments, the processor-executable instructions 620 are configured to cause implementation of a system, such as at least some of the example system 100 of FIG. 1, for example.

FIG. 7 illustrates an example computing device 700 that is configured and/or programmed with one or more of the example systems and methods described herein, and/or equivalents. The example computing device 700 may be the computer 715 that includes a processor 720, a memory 735, and I/O ports 745 operably connected by a bus 725. In one embodiment, the, the computer 715 may include logic of the matching module 105 configured to facilitate the system 100 and/or the method 200 shown in FIGS. 1-2. In different embodiments, the logic of the matching module 105 may be implemented in hardware, a non-transitory computer-readable medium 705 with stored instructions, firmware, and/or combinations thereof. While the logic of the matching module 105 is illustrated as a hardware component attached to the bus 725, it is to be appreciated that in other embodiments, the logic of the matching module 105 could be implemented in the processor 720, stored in memory 735, or stored in disk 755.

In one embodiment, logic of the matching module 105 or the computer 715 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application specific integrated circuit (ASIC) programmed to implement rule based source sequencing for allocation. The means may also be implemented as stored computer executable instructions that are presented to computer 715 as data 710 that are temporarily stored in memory 735 and then executed by processor 720.

The logic of the matching module 105 may also provide means (e.g., hardware, non-transitory computer-readable medium 705 that stores executable instructions, firmware) for performing rule based source sequencing for allocation.

Generally describing an example configuration of the computer 715, the processor 720 may be a variety of various processors including dual microprocessor and other multi-processor architectures. The memory 735 may include volatile memory and/or non-volatile memory. Non-volatile memory may include, for example, read-only memory (ROM), programmable read-only memory (PROM), and so on. Volatile memory may include, for example, random access memory (RAM), static random-access memory (SRAM), dynamic random access memory (DRAM), and so on.

The disks 755 may be operably connected to the computer 715 via, for example, the I/O interface 740 (e.g., card, device) and the I/O ports 745. The disks 755 may be, for example, a magnetic disk drive, a solid state disk drive, a floppy disk drive, a tape drive, a Zip drive, a flash memory card, a memory stick, and so on. Furthermore, the disks 755 may be a CD-ROM drive, a CD-R drive, a CD-RW drive, a DVD ROM, and so on. The memory 735 can store a process, such as within the non-transitory computer-readable medium 705, and/or data 710, for example. The disk 755 and/or the memory 735 can store an operating system that controls and allocates resources of the computer 715.

The computer 715 may interact with input/output (I/O) devices via the I/O interfaces 740 and the I/O ports 745. The I/O devices may be, for example, a keyboard, a microphone, a pointing and selection device, cameras, video cards, displays, the disks 755, the network devices 750, and so on. The I/O ports 745 may include, for example, serial ports, parallel ports, and USB ports. I/O controllers 730 may connect the I/O interfaces 740 to the bus 725.

The computer 715 can operate in a network environment and thus may be connected to the network devices 750 via the I/O interfaces 740, and/or the I/O ports 745. Through the network devices 750, the computer 715 may interact with a network. Through the network, the computer 715 may be logically connected to remote computers (e.g., the computer 715 may reside within a distributed computing environment to which clients may connect). Networks with which the computer 715 may interact include, but are not limited to, a local area network (LAN), a new area network (WAN), and other networks.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein.

The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing computer-executable instructions that when executed by a processor of a computer causes the processor to:
query a database containing invoice records where the query uses a parent item identifier to retrieve an invoice record that identifies a set of invoiced child items that are categorized under a parent item;
query a receipt record database using the parent item identifier to retrieve a receipt record that identifies a set of received child items that are categorized under the parent item;
parse the invoice record to identify the set of invoiced child items that are categorized under the parent item;
parse the receipt record to identify the set of received child items that are categorized under the parent item;
execute a comparing operation to compare a first quantity metric of the set of invoiced child items with a second quantity metric of the set of received child items to determine whether the first quantity metric is within a quantity threshold tolerance of the second quantity metric;
in response to the comparing operation determining a quantity match of the first quantity metric and the second quantity metric being within the quantity threshold tolerance, modify a data structure to indicate that the quantity match was determined for the parent item; and
in response to the comparing operation not determining the quantity match, generate a match fail result.

2. The non-transitory computer-readable medium of claim 1, wherein the computer-executable instructions for executing the comparing operation comprise computer-executable instructions to cause the processor to:
execute the comparing operation to compare a first cost metric of the set of invoiced child items with a second cost metric of the set of received child items to determine whether the first cost metric is within a cost threshold tolerance of the second cost metric;
in response to the comparing operation determining a cost match of the first cost metric and the second cost metric being within the cost threshold tolerance, modify the data structure to indicate that the cost match was determined for the parent item; and
in response to the comparing operation not determining the cost match, provide the match fail result.

3. The non-transitory computer-readable medium of claim 1, wherein the computer-executable instructions comprise computer-executable instructions to cause the processor to:
query a purchase order database using the parent item identifier to retrieve a purchase order listing a set of ordered child items that are categorized under the parent item;
parse the purchase order to identify the set of ordered child items that are categorized under the parent item;
execute the comparing operation to compare the first quantity metric of the set of invoiced child items with a third quantity metric of the set of ordered child items to determine whether the first quantity metric is within the quantity threshold tolerance of the third quantity metric;
in response to the comparing operation determining a second quantity match of the first quantity metric and the third quantity metric being within the quantity threshold tolerance, modify the data structure to indicate that the second quantity match was determined for the parent item; and
in response to the comparing operation not determining the second quantity match, provide the match fail result.

4. The non-transitory computer-readable medium of claim 1, wherein the computer-executable instructions comprise computer-executable instructions to cause the processor to:
query a purchase order database using the parent item identifier to retrieve a purchase order listing a set of ordered child items that are categorized under the parent item;
parse the purchase order to identify the set of ordered child items that are categorized under the parent item;
execute the comparing operation to compare a first cost metric of the set of invoiced child items with a second cost metric of the set of ordered child items to determine whether the first cost metric is within a cost threshold tolerance of the second cost metric;
in response to the comparing operation determining a cost match of the first cost metric and the second cost metric being within the cost threshold tolerance, modify the data structure to indicate that the cost match was determined for the parent item; and
in response to the comparing operation not determining the cost match, provide the match fail result.

5. The non-transitory computer-readable medium of claim 1, wherein a first child item categorized under the parent item has a first stocking keeping unit (SKU) and a second child item categorized under the parent item has a second SKU different than the first SKU, wherein the comparing operation compares a count of invoiced child items having SKUs categorized under the parent item with a count of received child items having SKUs categorized under the parent item.

6. The non-transitory computer-readable medium of claim 1, wherein the computer-executable instructions comprise computer-executable instructions to cause the processor to:
in response to the comparing operation not determining the quantity match, apply a pro-rate metric across child items categorized under the parent item.

7. The non-transitory computer-readable medium of claim 2, wherein the first quantity metric corresponds to a count of invoiced child items, the second quantity metric corresponds to a count of received child items, the first cost metric corresponds to unit costs of invoiced child items and the second cost metric corresponds to unit costs of received child items.

8. A computing system, comprising:
a processor connected to memory;
a matching module stored on a non-transitory computer readable medium and configured with instructions that when executed by the processor cause the processor to:
query an invoice record database using a parent item identifier to retrieve an invoice record listing a set of invoiced child items that are categorized under a parent item;
query a purchase order database using the parent item identifier to retrieve a purchase order listing a set of ordered child items that are categorized under the parent item;
parse the invoice record to identify the set of invoiced child items that are categorized under the parent item;
parse the purchase order to identify the set of ordered child items that are categorized under the parent item;
execute a comparing operation to compare a first cost metric of the set of invoiced child items with a second cost metric of the set of ordered child items to determine whether the first cost metric is within a cost threshold tolerance of the second cost metric;
in response to the comparing operation determining a cost match of the first cost metric and the second cost metric being within the cost threshold tolerance, modify a data structure to indicate that the cost match was determined for the parent item; and
in response to the comparing operation not determining the cost match, provide a match fail result.

9. The computing system of claim 8, wherein the instructions cause the processor to:
execute the comparing operation to compare a first quantity metric of the set of invoiced child items with a second quantity metric of the set of ordered child items to determine whether the first quantity metric is within a quantity threshold tolerance of the second quantity metric;
in response to the comparing operation determining a quantity match of the first quantity metric and the second quantity metric being within the quantity threshold tolerance, modify the data structure to indicate that the quantity match was determined for the parent item; and
in response to the comparing operation not determining the quantity match, provide the match fail result.

10. The computing system of claim 8, wherein the instructions cause the processor to:
query a receipt record database using the parent item identifier to retrieve a receipt record listing a set of received child items that are categorized under the parent item;
parse the receipt record to identify the set of received child items that are categorized under the parent item;
execute the comparing operation to compare a first quantity metric of the set of invoiced child items with a second quantity metric of the set of received child items to determine whether the first quantity metric is within a quantity threshold tolerance of the second quantity metric;
in response to the comparing operation determining a quantity match of the first quantity metric and the second quantity metric being within the quantity threshold tolerance, modify the data structure to indicate that the quantity match was determined for the parent item; and
in response to the comparing operation not determining the quantity match, provide the match fail result.

11. The computing system of claim 10, wherein the instructions for parsing the receipt record comprises instructions that cause the processor to:
parse the receipt record to identify one or more substitute items for the parent item; and
include the one or more substitute items within the set of received child items.

12. The computing system of claim 11, wherein a substitute item is not categorized under the parent item.

13. The computing system of claim 8, wherein the instructions cause the processor to:
retrieve a set of invoices from an invoice record database based upon the set of invoices listing one or more invoiced child items categorized under the parent item;
retrieve a set of receipts from a receipt record database based upon the set of receipts listing one or more received child items categorized under the parent item; and
execute the comparing operation to compare quantities of invoiced child items within the set of invoices with quantities of received child items within the set of receipts to determine whether there is a total quantity match within a quantity threshold tolerance.

14. The computing system of claim 13, wherein the instructions cause the processor to:
execute the comparing operation to compare costs of invoiced child items within the set of invoices with costs of received child items within the set of receipts to determine whether there is a total cost match within the cost threshold tolerance.

15. The computing system of claim 8, wherein the instructions cause the processor to:
retrieve a set of invoices from the invoice record database based upon the set of invoices listing one or more invoiced child items categorized under the parent item;
retrieve a set of purchase orders from a purchase order database based upon the set of purchase orders listing one or more ordered child items categorized under the parent item; and
execute the comparing operation to compare quantities of invoiced child items within the set of invoices with quantities of ordered child items within the set of purchase orders to determine whether there is a total quantity match within a quantity threshold tolerance.

16. The computing system of claim 15, wherein the instructions cause the processor to:
execute the comparing operation to compare costs of invoiced child items within the set of invoices with costs of ordered child items within the set of purchase orders to determine whether there is a total cost match within the cost threshold tolerance.

17. A computer-implemented method, the computer-implemented method involving a computing device comprising a processor, and the computer-implemented method comprising:
querying, by the processor, an invoice record database using a parent item identifier to retrieve a set of invoices based upon the set of invoices listing one or more invoiced child items that are categorized under a parent item;
querying, by the processor, a receipt record database using the parent item identifier to retrieve a set of receipts based upon the set of receipts listing one or more received child items categorized under the parent item;
executing, by the processor, a comparing operation to compare quantities of invoiced child items within the set of invoices with quantities of received child items within the set of receipts to determine whether there is a total quantity match within a quantity threshold tolerance;
in response to the comparing operation determining that there is a total quantity match, modifying, by the processor, a data structure to indicate that the total quantity match was determined for the parent item; and
in response to the comparing operation determining that there is not a total quantity match, providing, by the processor, a match fail result.

18. The computer-implemented method of claim 17, further comprising:
executing, by the processor, the comparing operation to compare costs of invoiced child items within the set of invoices with costs of received child items within the set of receipts to determine whether there is a total cost match within a cost threshold tolerance.

19. The computer-implemented method of claim 17, further comprising:
query, by the processor, a purchase order database using the parent item identifier to retrieve a set of purchase orders based upon the set of purchase orders listing one or more ordered child items categorized under the parent item; and
executing, by the processor, the comparing operation to compare quantities of invoiced child items within the set of invoices with quantities of ordered child items within the set of purchase orders to determine whether there is a second total quantity match within the quantity threshold tolerance.

20. The computer-implemented method of claim 19, further comprising:
executing, by the processor, the comparing operation to compare costs of invoiced child items within the set of invoices with costs of ordered child items within the set of purchase orders to determine whether there is a total cost match within a cost threshold tolerance.
